(19) United States
(12) Patent Application Publication
(10) Pub. No.: US 2002/0189406 A1
(43) Pub. Date: Dec. 19, 2002

(54) Bottle opener ring

(76) Inventor: Timothy Jude Hahn, San Juan, PR (US)

Correspondence Address: TIMOTHY HAHN, USCG NESU/MAT, 5 CALLE LA PUNTILLA, SAN JUAN, PR, 00901, US

(21) Appl. No.: 09/867,515

(22) Filed: May 31, 2001

(51) Int. Cl. B67B 7/16

(52) U.S. Cl. 81/3.55

(57) ABSTRACT

The invention is not technical in nature and is a simple device to be used to enhance convenience of persons opening bottled beverages.

CROSS-REFERENCE TO RELATED APPLICATIONS

| D438075 | February, 2001 | Van Meter |
|---|---|---|
| D34236 | March, 1901 | Herndon |
| D6009 | December, 1921 | Biehl, Sr. |
| D215807 | November, 1969 | Weingardt |
| D263274 | March, 1982 | Hastings |
| D266480 | October, 1982 | Reel |
| D291050 | July, 1987 | McIntire |
| D292499 | October, 1987 | Eddy |
| D303915 | October, 1989 | Knutson |
| D310158 | August, 1990 | Chan |
| D373941 | September, 1996 | Davis |
| 888580 | May, 1908 | Brinn |
| 1519816 | December, 1924 | Ward |
| 1578627 | March, 1926 | Baumgarten |
| 3495284 | February, 1970 | Weingardt |
| 4667544 | May, 1987 | Milo |
| 4765208 | August, 1988 | Sakosky |
| 4825728 | May, 1989 | Mitchell |
| 4869134 | September, 1989 | Sprecher |
| 5029495 | July, 1991 | Rosenberger |
| 5257566 | November, 1993 | Schultz |
| 5329832 | July, 1994 | Tegethoff |
| 5347890 | September, 1994 | Rufkahr |

### STATEMENT REGARDING FEDERALLY SPONSERED RESEARCH OR DEVELOPMENT

Not Applicable

### REFERENCE TO A MICROFICHE APPENDIX

Not Applicable

### BACKGROUND OF THE INVENTION

The field of endeavor to which this patent pertains is D08/33 bottle opener. Information known to me is the inconvenience incurred by persons opening beverage bottles by the necessity of retrieving a bottle opening device. Prior art attempted to resolve this by creating a bottle opener that can be worn on the hand. All prior art must be removed when not in use or risk looking awkward or obstructing dexterity of the hand. For example the opening device is on the inside of the hand obstructing ability to grip items, or the device must be worn on index finger and becomes awkward after opening the bottle.

### BRIEF SUMMARRY OF THE INVENTION

This bottle opener is worn on the finger as a ring and is used by making a fist, contacting bottle, and flexing the wrist. My design can be worn on any finger, presents an ornamental design, and will not interfere with gripping items. The object of the invention is to create a bottle opener which can be worn temporarily or permanently, does not interfere with the use of the hand, does not appear out of place on the hand, and opens bottles with a minimum of effort. This device will appeal not only to professionals; i.e. bartenders, but to any one who opens bottles.

### BRIEF DESCRIPTION OF THE SEVERAL VIEWS OF THE DRAWING

FIG. 1 is a 3 dimensional view of how the ring may look;

FIG. 2 is a side view of the ring;

FIG. 3 is an end view of the ring;

FIG. 4 is a depiction of how the ring may be used.

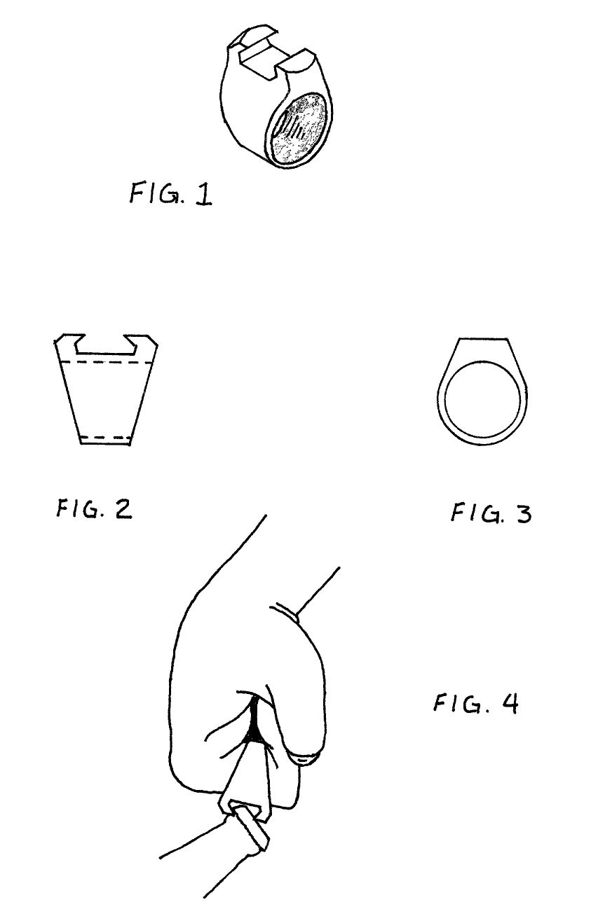

### DETAILED DESCRIPTION OF THE INVENTION

This device differs from what is old in three ways. First it may be worn as an ornamental device at any time or all the time. Second it may be worn on any finger the wearer chooses. Third it will not interfere with the gripping or handling of items. The process of making the device is simple. The device will be manufactured from cast aluminum by first making a patern from hard wood, plastic or similar material. The patern will be used to make a sand mold. Molten aluminum will be poured into the mold, and once hardened the molt will be split apart. The finished product may be polished or anodized a variety of colors. The ring may be produced in a variety of sizes to accommodate all persons.

1. The subject matter which I regard as the invention and different from all prior art are three things. First the ring may be reasonably worn as a cosmetic item at any time, wether in use or not, making it attractive to the non-professional. Second, since the opening device is on the outside of the hand, it will not interfere with the handling of items or other daily activities. Third, it may be used on whichever finger the user feels most comfortable. What is important here is the manner in which the ring functions, the actual design may be varied to make it more cosmetically appealing.
